(19) United States
(12) Patent Application Publication
(10) Pub. No.: US 2005/0160776 A1
(43) Pub. Date: Jul. 28, 2005

(54) Lock module for motor vehicle door

(76) Inventors: Marco Batzner, Rattelsdorf (DE); Ralph Gerstlauer, Coburg (DE); Matthias Schnapp, Sonnefeld (DE); Thomas Slavik, Schaittach (DE); Dirk Runte, Bamberg (DE); Horst Weber, Wirsberg (DE)

Correspondence Address: CHRISTIE, PARKER & HALE, LLP, PO BOX 7068, PASADENA, CA, 91109-7068, US

(21) Appl. No.: 10/991,081

(22) Filed: Nov. 16, 2004

(30) Foreign Application Priority Data
Nov. 19, 2003 (DE) 103 54 854.8

(51) Int. Cl. B60R 25/00

(52) U.S. Cl. 70/237

(57) ABSTRACT

A lock module for fitting in a motor vehicle door. The lock module compensates for structural tolerances and makes it possible to span large assembly gaps. This is achieved through a lock module for a motor vehicle door having a lock and a bearing bracket connected to the lock for supporting a door outside handle of the vehicle door. The lock and the bearing bracket are connected together through an adapter, the adapter and the bearing bracket are connected by a first sliding connection relatively displaceable along a first sliding direction and the lock and the adapter are connected by a second sliding connection displaceable along a second sliding direction, and the two sliding directions are arranged at an angle to each other.

### CROSS REFERENCE TO RELATED APPLICATION

This application claims priority of German Patent Application 103 54 854.8 filed on Nov. 19, 2003.

### BACKGROUND

From German laid open application DE 195 11 294 A1, a motor vehicle door is known having an assembly module. The assembly module has a support element on which are pre-fitted a door lock, an actuating device for the door lock as well as an outside handle holder or bearing bracket for mounting the outside door handle of the motor vehicle door. Furthermore, guides are provided for guiding the window pane and covering a guide rod transferring an actuating force. The installation of the already known assembly module in the motor vehicle door is undertaken by inserting the assembly module through an opening in the door inside panel and into the interspace formed by the door outside panel and the door inside panel.

Owing to the very restricted space conditions inside the door box of motor vehicle doors and owing to the unavoidable manufacturing tolerances the assembly of a lock module having a door lock and bearing bracket is often very difficult. This is particularly the case when the door outside panel has in the region of the outside handle an inwardly directed curvature whereby the interspace between the door outside panel and door inside panel is narrowed down and positioning the lock module becomes increasingly more difficult.

Owing to the restriction in the interspace through the inwardly directed curvature of the door outside panel there is also the danger that when fitting the lock module sharp-edged regions of the lock module or assembly module supporting the lock module may damage the paintwork particularly on the inside of the outside panel which could lead to considerable rust damage including rusting right through which may go unnoticed.

The fitting of a lock module is also difficult because the lock as a rule has to be fitted against the door inside panel lying in the door plane and furthermore against the end side of the door which has been angled therefrom while the bearing bracket for the door outside handle has to be positioned from inside against the door outside panel.

### SUMMARY

An object of the invention is to provide a lock module which can be mounted in a particularly simple manner. The lock module thereby compensates for structural tolerances and enables large assembly gaps to be bridged.

According to the invention a lock module is provided with a lock and a bearing bracket connected to the lock for supporting a door outside handle of a vehicle door. The lock and bearing bracket are according to the invention connected together through an adapter whereby the adapter and bearing bracket are connected together by a first sliding connection which can be moved along a first sliding direction (or sliding axis). The lock and adapter are connected by a second sliding connection which can be moved relatively along a second sliding direction (or sliding axis). The two sliding directions (or sliding axes) are thereby arranged at an angular arrangement to each other. By “angular arrangement” is thereby meant that the two sliding axes have an angle greater than 0° and are thus not parallel to each other.

An important advantage of the lock module according to the invention can be seen in that it can be mounted relatively easily in a motor vehicle door since owing to the two sliding connections a displacement of the lock and bearing bracket relative to the adapter is possible so that the lock module can be adapted readily to the spatial conditions inside the vehicle door. Since the two sliding directions or sliding axes of the two sliding guides are at an angle to each other it is furthermore ensured that the bearing bracket and lock can be adjusted in two spatial dimensions, thus in two directions.

The first sliding connection can be formed particularly easily and thus advantageously by a sliding guide mounted on the adapter or on the bearing bracket whereby at least one positive locking element which matches the sliding guide is mounted on the relevant other part, thus on the adapter or bearing bracket respectively.

In a corresponding manner the second sliding connection is also preferably formed by a sliding guide on the adapter or on the lock. At least one matching positive locking element is provided on the relevant other part, thus on the bearing bracket or on the lock.

In order to further simplify the assembly and to enable an even better adaption of the lock module to the structural tolerances it is advantageous if the adapter is formed for swivel or articulated movement so that the two sliding directions or sliding axes can be pivoted relative to each other.

A swivel movement of this kind can be reached very easily and particularly advantageously if the adapter is formed in at least two parts. A first adapter part is then in connection with the bearing bracket and a second adapter part is in connection with the lock whereby the two adapter parts are connected together so that they can swivel relative to each other about at least one pivotal axis, more particularly about a bolt or hinge axis.

Alternatively the adapter can also be formed in one piece and have an elastic transition region so that the two sliding directions can be swivelled relative to each other through deformation of the elastic transition region.

In the event of a two-part adapter one of the two adapter parts preferably has a swivel bolt which forms the swivel axis on which the relevant other adapter part is mounted for swivel movement.

The swivel axis is preferably arranged substantially parallel to the first sliding direction of the first sliding guide and substantially perpendicular to the second sliding direction of the second sliding guide in order to enable a particularly simple optimum adjustment of the lock module.

It is preferable that the parts forming the lock module—namely, the lock, the adapter and the bearing bracket—are connected together to secure against loss. This can be achieved particularly easily and advantageously through detent elements on the two sliding guides which ensure their security against loss.

Furthermore, at least one of the two sliding guides—preferably both sliding guides, each have a spring which fixes a defined delivery position of its relevant sliding guide. The delivery position is thereby preferably selected so that the lock module can be readily used in the delivered state for fitting into the vehicle door.

In order to impede a break-in into the vehicle it is advantageous if the adapter is designed especially with an anti-theft safeguard. For this reference is made to the German laid open publication DE 101 43 986 A1 in which a cover cap is described which is used to fit the lock; this cap protects the lock against water spray and against manipulation and break-in from outside. The adapter is preferably also provided in the lock module with a spray and/or break-in guard as described in connection with the cap in German laid open publication DE 101 43 986 A1. Furthermore locator and/or fixing elements for cables and/or plugs can also be integrated in the adapter.

### BRIEF DESCRIPTION OF THE DRAWINGS

FIG. 1 shows a first exemplary embodiment in an exploded view for a lock module according to the invention with a two-part adapter;

FIG. 2 shows the exemplary lock module according to FIG. 1 in the assembled state;

FIG. 3 shows the exemplary lock module according to FIGS. 1 and 2 in plan view after the lock of the lock module has been swivelled in the direction of the bearing bracket;

FIG. 4 shows the opened up lock module according to FIG. 3 in side view;

FIGS. 5 and 6 show the closed lock module during the assembly processes in a motor vehicle door and

FIG. 7 shows a further embodiment for a lock module according to the invention in which the adapter is designed in two parts and has an elastic transition region.

### DETAILED DESCRIPTION

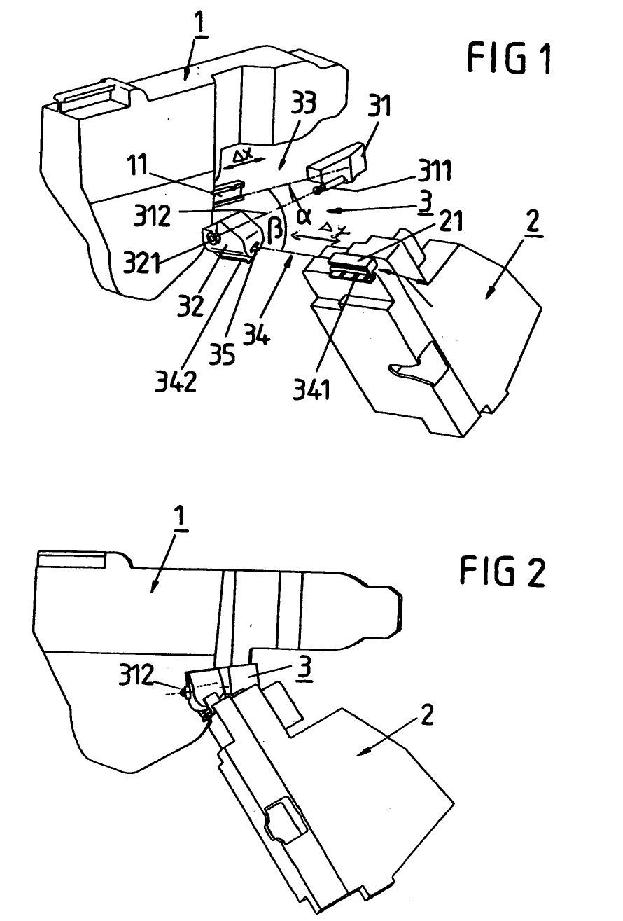

FIG. 1 shows an exemplary lock module with a bearing bracket 1 and a lock 2. The bearing bracket 1 and the lock 2 are connected through an adapter 3 which is in two parts and is formed by a first adapter part 31 and a second adapter part 32.

The first adapter part 31 is connected through a first sliding connection 33 to the bearing bracket 1. For this the bearing bracket 1 has a sliding guide 11 which is formed by a guide rail. The first adapter part 31 has a positive locking element which fits the guide rail 11 and which cannot be seen in FIG. 1.

The connection between the second adapter part 32 and the lock is based on a second sliding connection 34. The sliding connection 34 is formed by a slot 35 with a T-shaped cross-section in which a matching positive locking element 21 of the lock 2 is inserted.

As a result of the first sliding connection 33 the first adapter part 31 can be moved along a first sliding direction or sliding axis Δx relative to the bearing bracket 1. The lock 2 can be moved through the second sliding connection 34 relative to the second adapter part 32 along a second sliding direction or sliding axis Δy. As can be seen from FIG. 1 the two sliding directions Δx and Δy stand at an angle to each other; the angle β between the two sliding directions Δx and Δy amounts to about 90°.

The two adapter parts 31 and 32 are connected together for swivel movement. This swivel movement is ensured through a swivel bolt 311 which is formed integral on the first adapter part 31 and on which the second adapter part 32 is fitted by an opening 321. The swivel bolt 31 thus enables a further degree of freedom when the bearing bracket 1 and lock 2 are aligned relative to each other. In order to fit the two adapter parts the second adapter part 32 is pushed by its opening 321 onto the swivel bolt 311 of the first bearing part 31.

The first adapter part 31 is pushed onto the guide rail 11 of the bearing bracket 1 by means of the positive locking element in order to fit on the bearing bracket 1 whereby a relative displacement along the sliding axis Δy remains possible.

Thus through the adapter 3 a connection is made between the bearing bracket 1 and the lock 2 which enables a “relative alignment” of the bearing bracket 1 and the lock 2 by sliding along the two sliding axes Δx and Δy as well as by swivelling about the swivel axis 312 of the swivel bolt 311.

As can further be seen from FIG. 1, the second sliding connection 34 has detent elements or detent slots 341 mounted on the lock 2 and a detent nose 342 mounted on the second adapter part 32 which interacts with the detent slots 341. The detent slots 341 and the detent nose 342 are designed so that a fail-safe connection is guaranteed between the lock 2 and second adapter part 32. The lock 2 can thus not be easily removed from the T-shaped slot 35.

In a corresponding way the guide rail 11 of the bearing bracket 1 and the first adapter part 31 are provided with detent elements and a detent nose which guarantee a fail-safe connection between the bearing bracket 1 and the first adapter part 31.

The two sliding connections 33 and 34 preferably each have at least one spring which ensures a defined pretension and thus a defined position between the bearing bracket 1 and the adapter 3 on one side and the adapter 3 and lock 2 on the other side. The function of the springs then lies in guaranteeing a defined delivery position of the lock module to an automobile manufacturer so that the lock module always exists in a defined state for assembly and can be installed without any hand actions. A first detent stage is thereby provided which fixes the preassembly position, and a second detent stage which serves for the fail safe securing against loss. The displacement path or swivel path in between serves to bridge the assembly gaps.

It can furthermore be seen in FIG. 1 that the swivel axis 312 of the swivel bolt 311 is mounted at an angle α to the first sliding axis Δx. The angle α is however relatively small so that the swivel axis 312 of the swivel bolt 311 is aligned quasi parallel to the first sliding axis Δx and quasi perpendicular to the second sliding axis Δy. The size of the angle α is thereby selected so that the bearing bracket 1 and the lock 2 can be brought into an optimum relative position relative to each other in which simple fitting of the lock module in the relevant vehicle door is possible.

FIG. 2 shows the lock module according to FIG. 1 in the assembled state. The bearing bracket 1 can be seen which is connected to the lock 2 through the adapter 3.

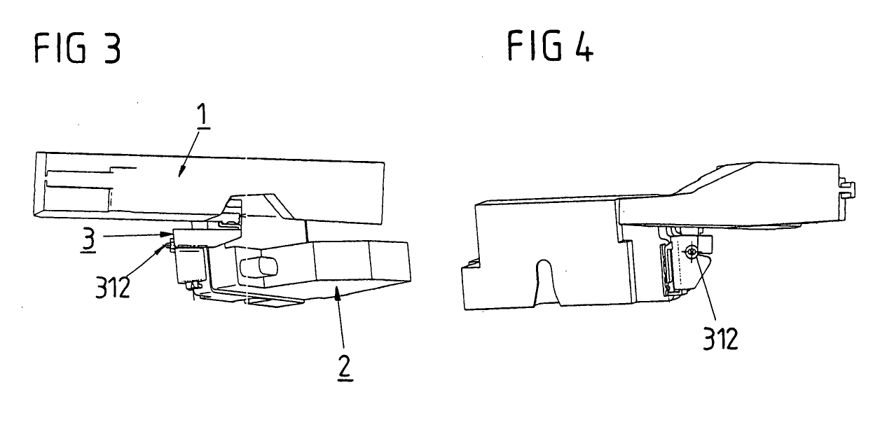

FIG. 3 shows the lock module according to FIGS. 1 and 2 in another view; the lock module can be seen from above.

FIG. 4 shows the lock module again in a different view, namely in the side view along the swivel axis 312 of the swivel bolt 311.

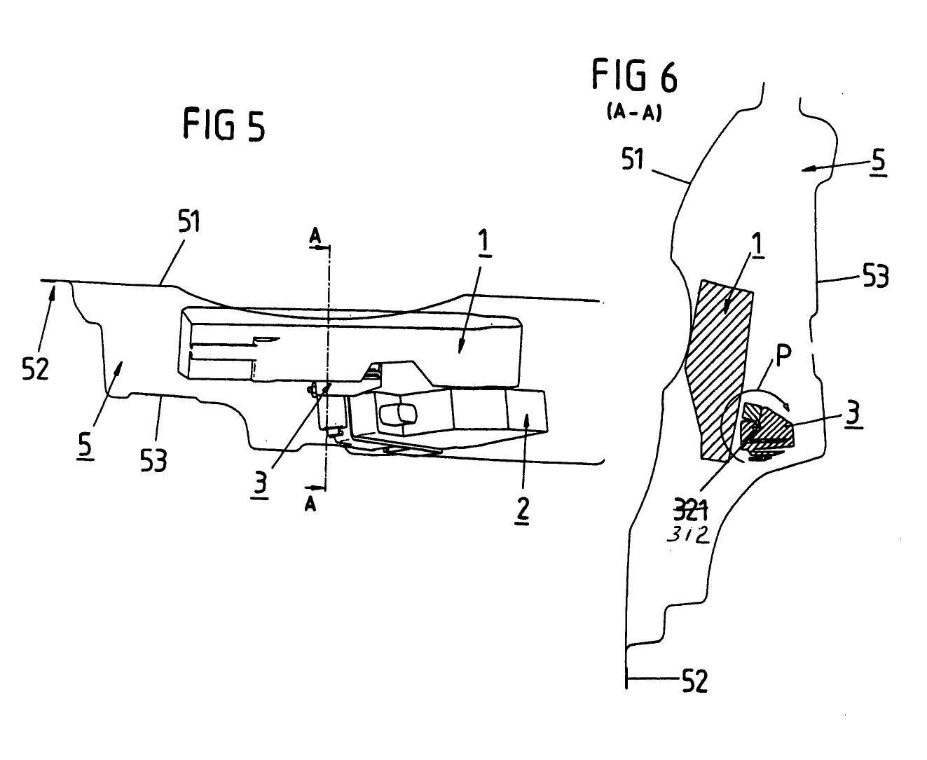

FIGS. 5 and 6 show the lock module according to FIG. 1 as it is installed in a motor vehicle door 5. The vehicle door 5 has an outer panel 51 which is connected to a door inner panel 53 in a flanged edge region 52.

From FIG. 5 it can be clearly seen that by folding the lock module up a very compact arrangement of the bearing bracket 1 and lock 2 is reached so that the lock module can be readily adjusted and fixed in the vehicle door. By swivelling about the swivel axis 312 of the swivel bolt 311 and sliding along the sliding axes Δx and Δy the lock module can then be “unfolded” inside the vehicle door 5 whereby a simple alignment and adjustment of the bearing bracket 1 relative to the outer panel 51 and a simple alignment and adjustment of the lock 2 relative to the end side of the motor vehicle door 5 becomes possible. Assembly tolerances inside the vehicle door 5 can thus be readily compensated.

FIG. 6 shows for reasons of clarity only the bearing bracket 1 and the adapter 3; the lock 2 is not shown. The arrow P in FIG. 6 shows how the adapter 3 can be swivelled about the swivel axis 312 of the swivel bolt 311. Owing to the position of the section A-A the lock 2 is not shown; only the sectional faces of the section A-A are shown so that the lock cannot be seen in this cross-section.

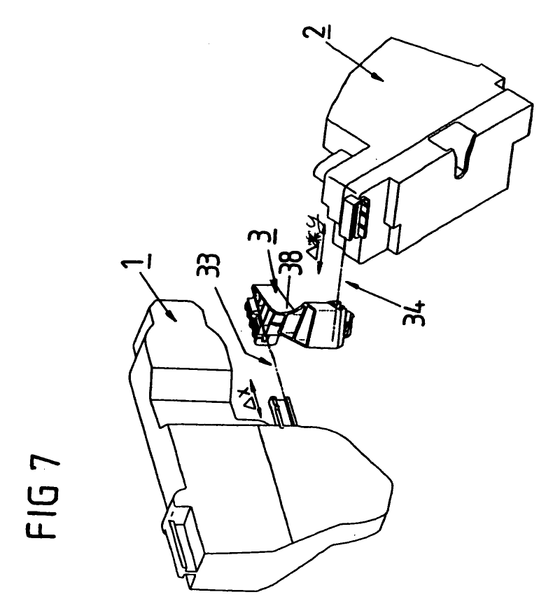

FIG. 7 shows a further exemplary embodiment for a lock module. A bearing bracket 1 is seen which is connected to a lock 2 through an adapter 3. Unlike the first embodiment according to FIGS. 1 to 6 the adapter 3 is here however designed in one piece. Instead of a swivel bolt in the embodiment according to FIG. 7 an elastic transition region 38 is provided which ensures a certain swivel action of the two connection regions 33 and 34 between the bearing bracket and the adapter 3 and between the lock 2 and the bearing bracket 3.

With the embodiment according to FIG. 7 a displacement of the bearing bracket 1 relative to the adapter 3 along the sliding axis Δx and a displacement of the lock 2 relative to the adapter 3 along the sliding axis Δy are possible; furthermore a swivel movement of the two sliding axes Δx and Δy is possible through the transition region 38.

1. A lock module for a motor vehicle door, comprising:
a lock; and
a bearing bracket in connection with the lock for supporting a door outside handle of the motor vehicle door; wherein the lock and the bearing bracket are connected together through an adapter, and wherein the adapter and bearing bracket are connected by a first sliding connection such that the lock and the bearing bracket are displaceable relative to each other along a first sliding direction and the lock and the adapter are connected by a second sliding connection such that the lock and the adapter are displaceable relative to each other, along a second sliding direction and the two sliding directions are arranged at an angle to each other.

2. The lock module according to claim 1, wherein the first sliding connection comprises a sliding guide mounted on one of the adapter and the bearing bracket, and at least one matching positive locking element which is mounted on the other of the bearing bracket and the adapter.

3. The lock module according to claim 1 or 2, wherein the second sliding connection is formed through a sliding guide mounted on one of the adapter and on the lock and through at least one matching positive locking element which is mounted on the other of the lock and adapter.

4. The lock module according to claim 1, wherein the adapter is articulatable so that the two sliding directions can be swivelled relative to each other.

5. The lock module according to claim 4, wherein the adapter is designed at least in two parts whereby a first adapter part is connected to the bearing bracket and a second adapter part is connected to the lock, and wherein the two adapter parts are connected for swivel movement about at least one swivel axis.

6. The lock module according to claim 5, wherein one of the first and second adapter parts has a swivel bolt on which the other adapter part is fitted for swivel movement.

7. The lock module according to claim 1, wherein the adapter is formed in one part and has an elastic transition region such that the two sliding directions are able to swivel relative to each other through deformation of the elastic transition region.

8. The lock module according to claim 5, wherein the at least one swivel axis is arranged substantially parallel to the first sliding direction of the first sliding guide and substantially perpendicular to the second sliding direction of the second sliding guide.

9. The lock module according to claim 1, wherein the two sliding guides have detent elements to which the lock, the adapter and the bearing bracket are connected to secure against separation.

10. The lock module according to claim 1, wherein at least one of the two sliding guides has a spring which fixes a defined delivery position of the at least one sliding guide.

11. The lock module according to claim 1, wherein the adapter has an anti-theft design.

12. The lock module of claim 5, wherein the at least one guided axis comprised one of a bolt axis and a hinge axis.

13. The lock module of claim 1, wherein the two sliding guides have springs which fix a defined delivery position of the sliding guides.
